(19) United States
(12) Patent Application Publication
(10) Pub. No.: US 2003/0023556 A1
(43) Pub. Date: Jan. 30, 2003

(54) Method for providing personal identification

(76) Inventor: Charles Holloway JR., Cartersville, GA (US)

Correspondence Address: Sanford J. Asman, 570 Vinington Court, Dunwoody, CA, 30350, US

(21) Appl. No.: 09/912,889

(22) Filed: Jul. 25, 2001

(51) Int. Cl. G06F 17/60

(52) U.S. Cl. 705/45; 705/42

(57) ABSTRACT

Checks are provided with photographs of the payee to help prevent fraud when the checks are presented for negotiation. The checks include images which are stored on the payor's data processing system using filenames which are uniquely associated with each payee. In an alternative embodiment of the invention, personal checks are prepared using commercially available check printing software in which images are “predistorted” in a manner which insures that when the checks are ultimately printed by software which “distorts” an image, the combined “predistortion” and “distortion” result in a normal image.

### BACKGROUND OF THE INVENTION

The present invention relates to a method and system for preventing fraud. In particular, the invention relates to a method and system for preventing the fraudulent negotiation of checks and similar documents by providing personal identification on the document, itself.

As is well known, crimes involving check fraud and identity fraud are widespread, and are among the fastest growing types of economic crimes in the United States. In particular, there are several types of such crimes involving the negotiation of checks by persons not authorized to do so. These include forged signatures, where legitimate blank checks are used with an imitation of the payor's signature; counterfeit checks, where checks are produced, typically using modem color copying and desktop publishing capabilities; and altered checks, in which information on a legitimate check, such as the name of the payee or the check amount is changed to benefit the perpetrator.

It has been estimated, that check fraud losses in the U.S. exceed $10 billion annually. The cost of this fraud is absorbed by banks and retailers, and is ultimately passed on to consumers. Advances in color copier and scanner technology have merely worsened the problem, as they have made it easy to reproduce valid checks, and to create checks having valid information by persons not authorized to do so.

In many situations involving check fraud, checks intended for a particular individual, such as payroll checks (or paychecks), tax refunds, social security checks, welfare checks, are diverted, and used by others. In other cases, unauthorized individuals write personal checks on stolen or counterfeited checks. In either of these situations, an improved ability to identify the payee (in the case of business or government checks) or the maker (in the case of personal checks) would provide a large step toward reducing or eliminating check fraud, in that the recipient of the check would readily be able to confirm the identity of the person negotiating the check merely by comparing the photograph on the check with the person attempting to negotiate it.

In the past there have been various efforts made to address the problem involving the negotiation of checks by persons who were not known to the person receiving the check. In one system, commonly used in banks, a fingerprint is applied to the check by the person negotiating it, if they are not account holder in the bank. In another system, described in U.S. Pat. No. 6,106,020 entitled FRAUD PREVENTION METHOD AND SYSTEM, which issued to Q. Leef, et al. on Aug. 22, 2000 (“the '020 Patent”), a method for fraudulent use of a document, such as a check, is described. In the system described in the '020 Patent, a digital photograph is taken of a person, at the location where the person cashes a check, for example. The digital photograph is then printed on the check. Alternatively, the '020 Patent describes using the system described therein on other documents, such as baggage claim checks, or a method for placing identifying information on so-called “starter checks”. While the '020 Patent describes the use of a digital photograph of the person negotiating a check as a means for identifying that person, it totally fails to address the issue of whether the person negotiating the check is the payee to whom the check was actually made out. Consequently, the result is that the system and method described in the '020 Patent just provides, at considerably higher cost, an alternative to the faster, cheaper method of having the person negotiating the check apply his fingerprint thereon.

Accordingly, it would be an improvement in check security if the checks were already printed with an image of the payee to whom the check was made out, rather than trying to take the time and incurring the equipment expense of printing a digital photograph on a check when it is presented.

### SUMMARY OF THE INVENTION

The present invention is a method for providing personal identification on checks issued by a payor to payees. In accordance with the invention, the first step conducted is to obtain a digital image of each payee. Next, unique filename is assigned to each digital image with the filename being uniquely associated with each payee. Next the digital images are stored on a computer storage medium using each of the unique filenames.

To print checks in accordance with the invention payee data for check to be printed is selected. The payee data includes the unique filename associated with each payee. Each check is printed using the payee data for the check, along with an image of the payee retrieved from the computer storage medium using the unique filename. When the following steps have been performed each check will include, in addition to the other information, a photographic image of the payee to whom the check was written.

### BRIEF DESCRIPTION OF THE DRAWING

In the drawing:

FIG. 1 is a schematic view of a data processing system of the type used to conduct the check printing method of the preferred embodiment of the invention;

FIG. 2 is an illustration of a business or government check printed in accordance with the invention;

FIG. 3 is a flow chart illustrating the method of storing and naming photographic images in accordance with the preferred storage method used in the present invention;

FIG. 4 is a flow chart illustrating the preferred embodiment for printing checks, as used in the present invention;

FIG. 5 is an illustration of a personal check prepared in accordance with the invention; and

FIG. 6 is a flow chart illustrating the inventive method for generating blank personal checks using commercially available check preparation software.

### DETAILED DESCRIPTION OF EXEMPLARY EMBODIMENTS

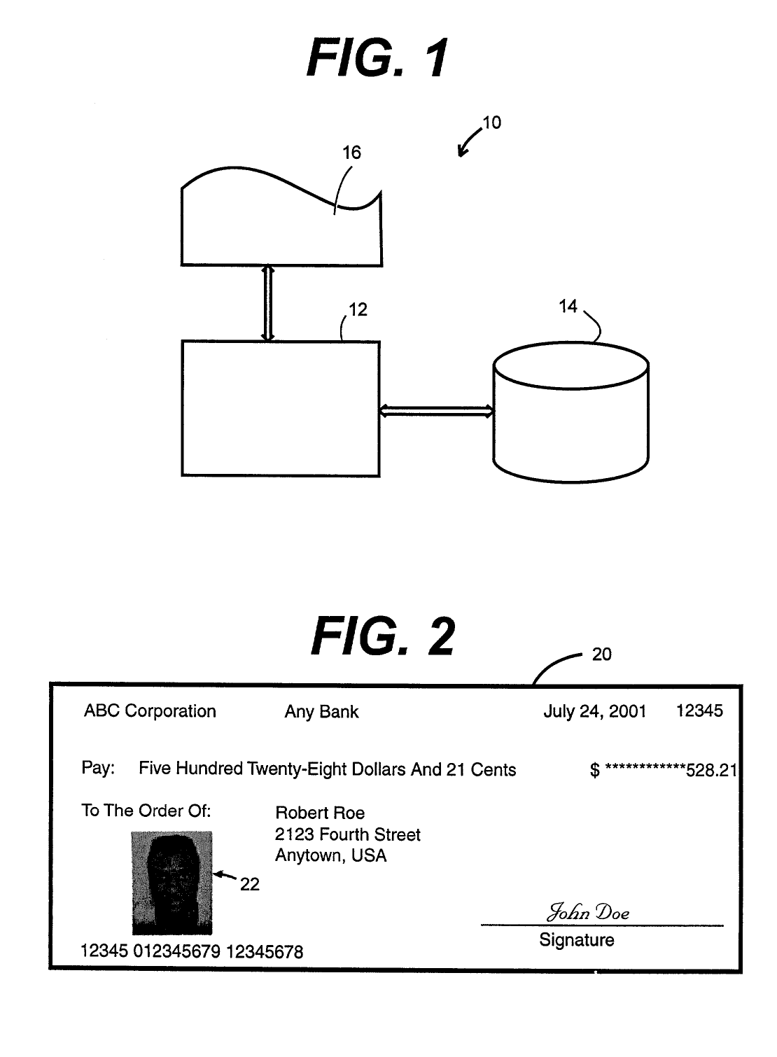

In many cases checks intended for a particular payee, e.g., government checks and corporate pay checks, are prepared on a periodic basis. Referring first to FIG. 1, the information needed to prepare such checks is traditionally maintained in a data processing system 10 which includes a computer 12, at least one memory storage device 14, which is typically comprised of tape drives and/or computer disk drives, and a printer 16, on which checks are actually printed. Depending on the size of the data processing system 10 and the number of payees to be included, the storage device 14 can be one or more floppy disk drives, fixed hard drives, removable hard drives, CD-ROM drives, DVD drives, tape drives, or any combination of those, or other suitable, mechanical or solid state memory devices. As will be understood by those skilled in the art, the data retained by the storage device 14 will include at least sufficient information to prepare the checks, e.g., the payee's name and the amount of the check, although commonly more information such as the payee's Social Security Number and/or employee number, will also be present. Further, personal data, such as the payee's address, is generally also present, so that the checks prepared by the data processing system can be mailed using standard window envelopes.

Referring to FIG. 2, a check 20 in accordance with a first embodiment of the present invention is shown. The check 20 is a standard paycheck issued by a payor, ABC Company, to an employee, Robert Roe. The check 20 differs from standard paychecks in that it includes a photograph 22 of employee, Roe. Thus, when Roe seeks to cash, or otherwise negotiate the check 20, a party receiving the check 20 can easily compare Roe's appearance to the photo 22 on the check 20. If the photo 22 matches the appearance of the person seeking to negotiate the check 20, then the party receiving the check can be reasonably certain that Roe, the payee, who appears in the photo 22, is also the person to whom the check 20 was originally issued. The comparison made at the point of negotiation, then becomes one of comparing the person to the photo 22 on the check 20, rather than trying to compare the image of the person from some personal identification, such as a driver's license. This is particularly, beneficial, as the use of modem computer equipment makes it relatively easy for someone to obtain and produce fake identification, such as a fake driver's license, which could be made to appear to look like a check fraud perpetrator, but not like the person to whom the check was originally issued.

In order to produce the paycheck 20 of FIG. 2, the present invention requires that digitized photographs of persons to whom checks are to be issued be created and stored on a computer readable medium. Such images are readily created by either scanning photographs or by taking photographs using digital cameras in a manner well known in the art. The photos are typically stored as a digital image in a format suitable for images, such as a “.jpg”, “.bmp”, “.tif”, or other suitable format. In the case of paychecks, each such photograph must be given a unique filename, which filename is stored on the computer's storage device 14 (See, FIG. 1), typically a hard drive, in a database associated with the information contained about each employee. As will be obvious to those skilled in the art, in the case of government checks, the payee's photographs will be stored on the computer's storage device 14 (See, FIG. 1). Thus, in the preferred embodiment of the invention, the database which contains employee (or payee) data will also include the filename of the photograph of the payee. As an alternative, it is possible to store the payee's photograph as a field in the database, itself, provided that the database is one which is capable of storing a binary large object (“BLOB”).

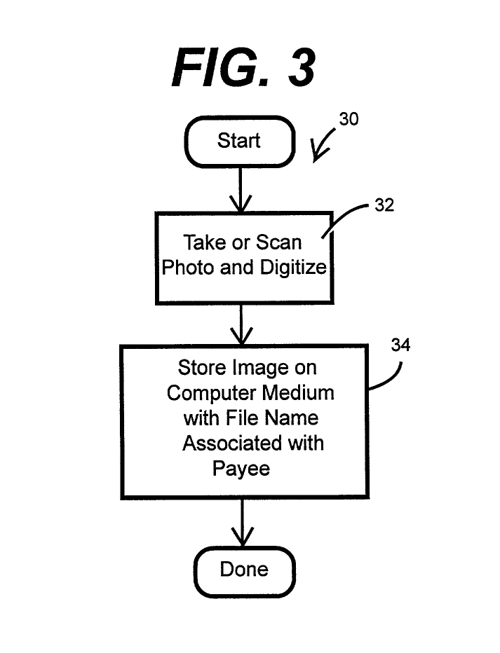

With reference to FIG. 3, a flowchart 30 illustrates the steps for storing payee photographs in accordance with the present invention. First, a payee's photograph must be provided as an image in digital format. As shown at step 32, this is accomplished by taking a photograph using a digital camera, or by scanning a conventional photograph to create a photographic image file. Next, as shown at step 34, the photographic image file is stored on the computer medium with a unique filename which is associated solely with the employee or other payee. As it is necessary to have some way to uniquely identify the image file associated with each person, in the preferred embodiment of the invention the filename assigned to each photograph could be the employee's Social Security Number, the employee's employee ID number, or a unique key which can be a field in the record in the case where the payee records are maintained in a relational database. Thus, in accordance with a preferred embodiment of the invention, the filename associated with a government issued check could be {SSN} .jpg, where “{SSN}” is the payee's Social Security Number, and “.jpg” denotes the type of file created. Those skilled in the art will recognize that photos taken by digital cameras are typically automatically named when the photograph is taken, with the names assigned by the digital camera generally being in a form which includes both letters and a number, such as “IMG_{—}9123.jpg”. When images are scanned, on the other hand, the filename associated with the scanned image is typically assigned by the person who is storing the scanned image. In each of these cases, it is possible for the filename associated with the image to be a duplicate of one assigned previously, e.g., by another digital camera, or by an individual, in the case of a scanned image. Thus, the present invention requires that the filename assigned to the image (along with the path, where the file is stored), be associated with the payee whose photograph was taken. As will be understood by those skilled in the art, this is a critical aspect of the present invention which was not heretofore described.

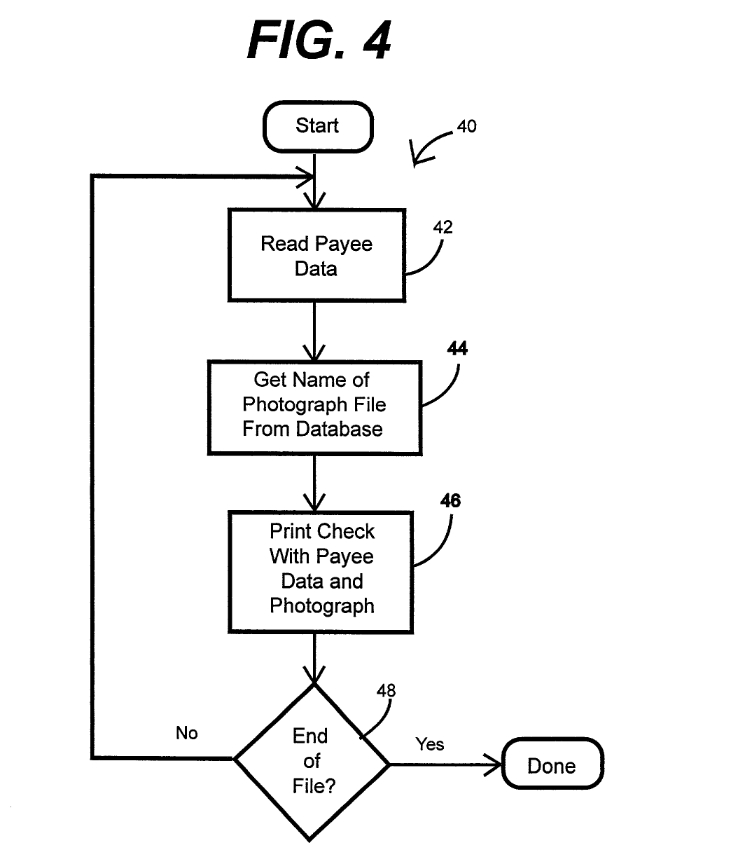

Referring to FIG. 4, the procedure for printing checks in accordance with the present invention is described in flowchart 40. Assuming checks are being printed in a typical batch process, on the printer 16, shown in FIG. 1, payee data is read at step 42. The data read includes the filename of the image of the payee, as shown at step 44. Using the filename retrieved at step 44, the check is printed, at step 46, with the appropriate payee's name, the amount due the payee, and the payee's image. In a typical batch check printing process after each check is printed, the computer will check (at step 48) whether the end-of-file (“EOF”) has been reached. If so, the process will end. Alternatively, the next payee's record is read, and the process is be repeated.

The method described above is suitable for use with checks which are sent to payees, such as the recipients of periodic government checks and/or business checks. However, another major area of fraud involves the use of personal checks. In the case of personal checks it is best for the check to include a photograph of the maker of the check, rather than a photograph of the payee. Thus, when a person uses his personal check, the recipient of the check is able to compare the photograph on the check with the appearance of the person who has written the check. While it would still be possible for someone to try to commit fraud by placing their own photograph on a counterfeit check, by doing so they will be providing the police, or other authorities, with their own photographs, which will assist in their ultimate capture and prosecution.

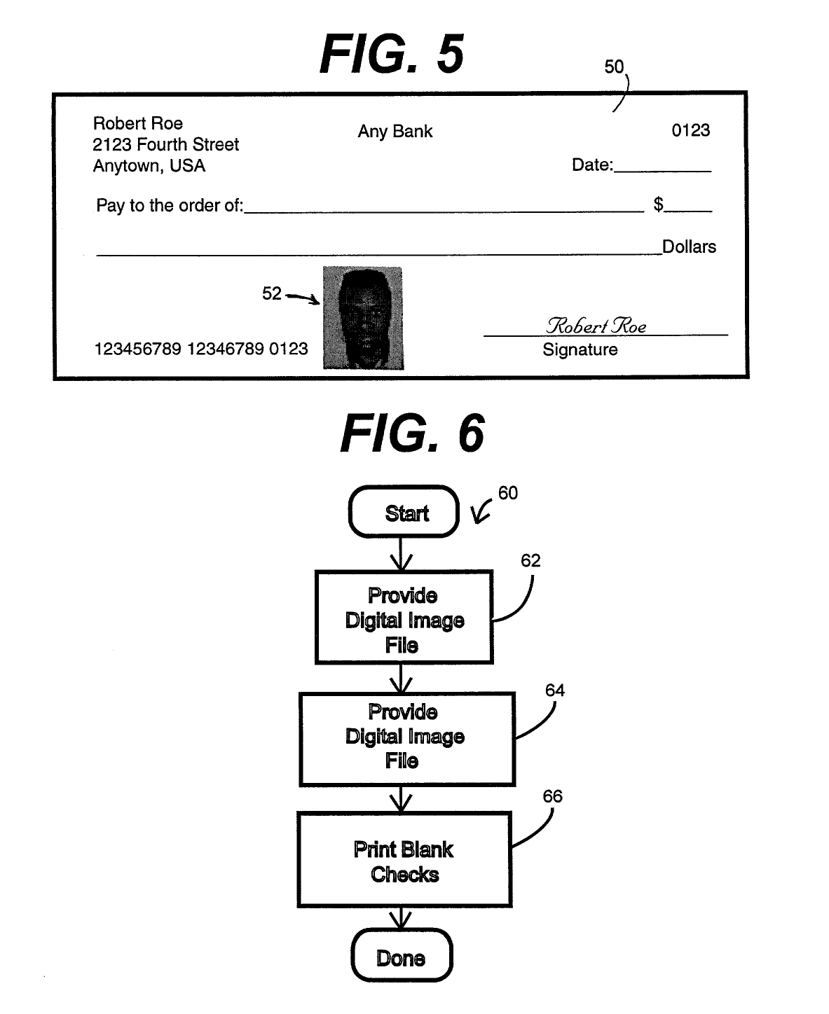

With reference to FIG. 5, a personal check 50 is shown which includes a photograph 52 of the person on whose account the check is drawn. In order to create the check 50, one would follow the procedure set forth in the flow chart 60 in FIG. 6, which illustrates the method for creating personalized checks which include the photograph 62. As shown, the first step 62 in accordance with the present invention is to provide a digital image file. Next, one would use the digital image file in software designed for check printing, such as VersaCheck from MIPS Dataline America, Inc., 10840 Thommint Road, Suite 100, San Diego, Calif. 92127. Those skilled in the art will realize, however, that it may not be possible to simply use a standard digitized photograph in such software, as the software may distort the image. By way of example, the software may attempt to “widen” an image by changing its aspect ratio. Thus, if the software automatically modified the aspect ratio of a “.jpg” file to make it twice as wide, without changing its height, then a photograph, so modified would be very distorted. In accordance with the present invention, such distortion is prevented when the image is printed by “predistorting” the image. Thus, if the check printing software changes the aspect ratio by making the width twice as wide as it was, without changing the height of the image, the image should be “predistorted” by processing it in image processing software, such as Adobe Photoshop, to make its width one-half what it was, without changing its with. Accordingly, when the predistorted image is processed by the check writing software, and the image width is doubled, it will be restored to its original aspect ratio. Accordingly, in accordance with tthe method of the present invention, the digital image is “predistorted” at step 64, so that it will be available for “distorting” by the check printing software when blank checks are printed, as shown at step 66. Those skilled in the art will recognize that the term “predistort” is used herein to refer to the reverse of the distortion caused by the check printing software, such that the combination of “predistortion” and “distortion” result in an image which is the desired normal image.

Additional benefits of the present invention include the ability to insert encoded information on the image itself, which could correspond to personal information of the payee or check maker. By way of example, the payee's Social Security Number, or his Driver's License number, or other data could be digitally encoded on the photographs 22 (FIG. 2), or 52 (FIG. 5), such that they could be viewed using monocolor light or a suitable filter.

While a number of variations of the present invention have been described, other variations will be apparent to those skilled in the art, and all such variations are intended to be included within the scope of the present invention. As will be obvious, numerous other variations can be made, without departing from the spirit or scope of the invention.

I claim:

1. A method for providing personal identification on checks issued by a payor to payees which includes the steps of:
(a) obtaining a digital image of each payee;
(b) assigning a unique filename to each said digital image which is uniquely associated with each payee;
(c) storing each said digital image on a computer storage medium using each said unique filename;
(d) selecting payee data for check printing, said data including, for each payee, said unique filename;
(e) printing checks for said payee data for each check, each said check being printed with an image of the payee retrieved from said computer storage medium using said unique filename,
whereby each check will include, in addition to the other information, a photographic image of the payee to whom such check was written.

2. The method for providing personal identification on checks issued by a payor to payees of claim 1 wherein the step of obtaining a digital image is accomplished by taking a photograph using a digital camera.

3. The method for providing personal identification on checks issued by a payor to payees of claim 1 wherein the step of obtaining a digital image is accomplished by scanning a conventional photograph.

4. The method for providing personal identification on checks issued by a payor to payees of claim 1 wherein the step of assigning a unique filename is accomplished by using assigning a name uniquely associated with each said payee, such name being selected from the group consisting of the payee's social security number, the payee's employee identification number, and the key field in the database containing the payee's data.

5. The method for providing personal identification on checks issued by a payor to payees of claim 1 wherein the step of selecting payee data for check printing is accomplished by using data from each payee's data record to generate a filename which is uniquely associated with each said payee's image file.
